(19) United States
(12) Patent Application Publication
(10) Pub. No.: US 2003/0206998 A1
(43) Pub. Date: Nov. 6, 2003

(54) Container for spoonable food products

(75) Inventors: Derek J. Romeo, Evanston, IL (US); Edmund A. Weaver, Oshkosh, WI (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/138,851

(22) Filed: May 3, 2002

(51) Int. Cl. A23B 4/00

(52) U.S. Cl. 426/115

(57) ABSTRACT

The invention is preferably embodied in a container configured for improved handling, storage, shipping, and evacuation. The container may comprise a body having a substantially rectangular footprint for improved shipping and storage, a handle for improved handling, and interior surfaces configured for improved product dispensing.

### FIELD OF THE INVENTION

The present invention relates generally to a container, and more particularly to a container for a spoonable food product.

### BACKGROUND OF THE INVENTION

In providing a container for commercial packaging of spoonable food products, among the considerations that must be addressed are the handling of the container by a user, the storage of the container by the user, and the packaging of the container with other like containers. Due to the viscosity typical of spoonable food products such as mayonnaise, consideration must also be given to the dispensing of product from containers using a spoon, spatula, or the like. Containers also should have an aesthetically pleasing appearance and be capable of inexpensive mass production.

Many prior art containers are generally cylindrical. Large containers of this shape can be unwieldy, particularly when the container is of a larger size, such as a one gallon container which may contain product weighing eight pounds or more. In dispensing product from such containers, the user often may wish to tilt the container over a receptacle using one hand, while spooning product out with a utensil held in the other hand. Large containers are often very difficult for a user to handle in order dispense product in this manner.

Another consideration is the ability of the container to be efficiently packaged for shipping. Efficiently packaged containers can reduce the amount of packing material, such as cartons and carton dividers, used during shipping. Efficiently packaged containers can also reduce the total volume, including unused space, for shipping and thereby lower shipping costs determined by volume. Cylindrically shaped containers can particularly be inefficient to package and ship.

In addition, many prior art containers for spoonable product are not sized for efficient storage by a user. Shelving shelf space for such containers is often between 12 and 14 inches high, while many prior art containers are less than 10 inches in height. Unused vertical shelving space reduces the total volume of food product that may be stored on the shelving.

Another problem with many prior art containers is that they present obstacles to dispensing of product, in that their openings are not sufficiently wide, and/or they include shoulder regions from which product may be difficult to remove.

Containers in the prior art that have handles or other gripping portions frequently present obstacles to removal of highly viscous spoonable products such as mayonnaise or other products of similar consistency, i.e., products that are not pourable. Such obstacles include concave interior regions formed adjacent exterior indentations associated with gripping portions or handles. In addition, interior ridges or grooves are often formed in such containers.

Containers have also been provided with hollow handles that permit flow from the container thereinto. Once product has entered a hollow handle, it may be difficult to remove. A spoonable product having a high viscosity may be very difficult to remove from a hollow handle.

Other considerations in providing containers for spoonable food product include having ample label display area to enable a user to readily identify the contents of the container. Often, cylindrical containers are provided with labels extending only partly around their circumference that are not visible in all bottle orientations.

There is a need for an improved container that addresses all of the above considerations.

### SUMMARY OF THE INVENTION

The invention provides a container for a food product that offers improved handling, shipping, storage, and product dispensing capabilities. The container generally may comprise a body having a generally rectangular footprint for improved shipping and storage, and a handle and interior surfaces configured to facilitate dispensing.

The container may comprise a body having a generally horizontal bottom wall. An annular neck may be disposed at the top of the container body for defining an opening through which product may be removed. The opening may be sized to permit insertion of a utensil into the interior for removing product therefrom. An upstanding sidewall may extend from the bottom wall to the neck. The sidewall has an upper end and a lower end. The sidewall upper end includes a region of gradually decreasing cross-section toward the neck. The region of gradually decreasing cross-section provides an angled surface facilitating removal of the product, such as by dumping or with a utensil. The angled surface of the sidewall may comprise a substantially smooth surface free from substantial ridges or other obstructions which can hinder removal of product from the interior of the container.

The sidewall also includes a handle having first and second ends attached thereto. The first end of the handle is attached to the sidewall upper end, and the second end is attached to the sidewall lower end. The handle may include a substantially hollow region. There is provided a connection between the body and the handle, whereby the connection prevents product from entering the hollow region of the handle from the body. Thus, product may be prevented from flowing into the handle, thereby simplifying removal of the product from the container.

The sidewall proximate the handle may have an inwardly extending arcuate region between the first and second handle ends. The arcuate region of the sidewall is effective to allow for evacuation of the container with a utensil. The gradual arc allows for a smooth, surface lacking abrupt changes in cross-section to allow a utensil to readily scrape the interior of the container. The arcuate region of the sidewall may comprise a substantially smooth surface free from substantial ridges or other obstructions which can hinder product removal.

A lower region or portion of the container is located between the handle and the bottom wall. To allow for removal of product, the lower region may be linearly accessible from the opening. In particular, the portion of the sidewall below the second end of the handle may be linearly accessible via the opening.

The perimeter of the bottom wall may define a footprint for the container. The container may be configured so that the handle does not extend substantially beyond the footprint of the container. Thus, the handle does not interfere with the packaging of a plurality of such containers on a palate. In addition, the bottom wall may have a generally rectangular perimeter which increases the efficiency for which multiple containers may be stacked.

The container may be formed using an inexpensive material suitable for inexpensive mass production. According to an aspect of the invention, the container comprises a polymeric blow molded container. If the container is formed using blow molding techniques, the connection between the handle and the sidewall may comprise a pinched region to prevent entry of product into the hollow region of the handle.

The container may have a capacity of about one gallon, and a height selected to maximize storage space in the vertical distance between typical shelving of a user.

The opening may be provided with a lid for selectively permitting access to the interior of the container. The lid may be secured to the neck and cover the opening of the container via threads formed on the neck and lid. Alternatively, the neck may be provided with a ridge allowing for a snap on connection between the lid and the container effective to cover the opening thereof.

In an aspect of the invention, the container may be able to contain one gallon of spoonable food product, such as mayonnaise or other spoonable products.

In accordance with a method for evacuating a spoonable product from the interior of the container, the method may include grasping the handle in order to easily upend the container. The method may also include removing a lid from the neck of the container to expose an opening of the container. When the opening is tilted in a generally downward direction and the lid has been removed, product may flow therefrom. In addition to allowing product to flow from the interior of the container, the opening is sized to allow for insertion of a utensil thereinto. The container may be scraped with the utensil or otherwise evacuated along a gradually decreasing cross-sectional region adjacent the neck. Furthermore, the product may also be scraped or otherwise evacuated along a gradual arc extending between the upper and lower ends of the handle on the interior of the container with the utensil.

### BRIEF DESCRIPTION OF THE DRAWINGS

FIG. 1 is a perspective view of a container in accordance with an aspect of the invention;

FIG. 2 is a side elevational view of the container of FIG. 1;

FIG. 3 is a back side elevational view of the container of FIG. 1;

FIG. 4 is a front elevational view of the container of FIG. 1;

FIG. 5 is a top plan view of the container of FIG. 1;

FIG. 6 is a bottom plan view of the container of FIG. 1; and

FIG. 7 is a section view of the container of FIG. 1 taken along line 7-7 of FIG. 2.

### DETAILED DESCRIPTION OF THE DRAWINGS

The invention is preferably embodied in a container 10 for a spoonable product configured for improved handling, storage, shipping, and product removal. Preferred embodiments of the invention, wherein the container 10 comprises a body 20 having a substantially rectangular footprint for improved shipping and storage, a handle 60 for improved handling, and interior surfaces configured for improved product removal, are described below.

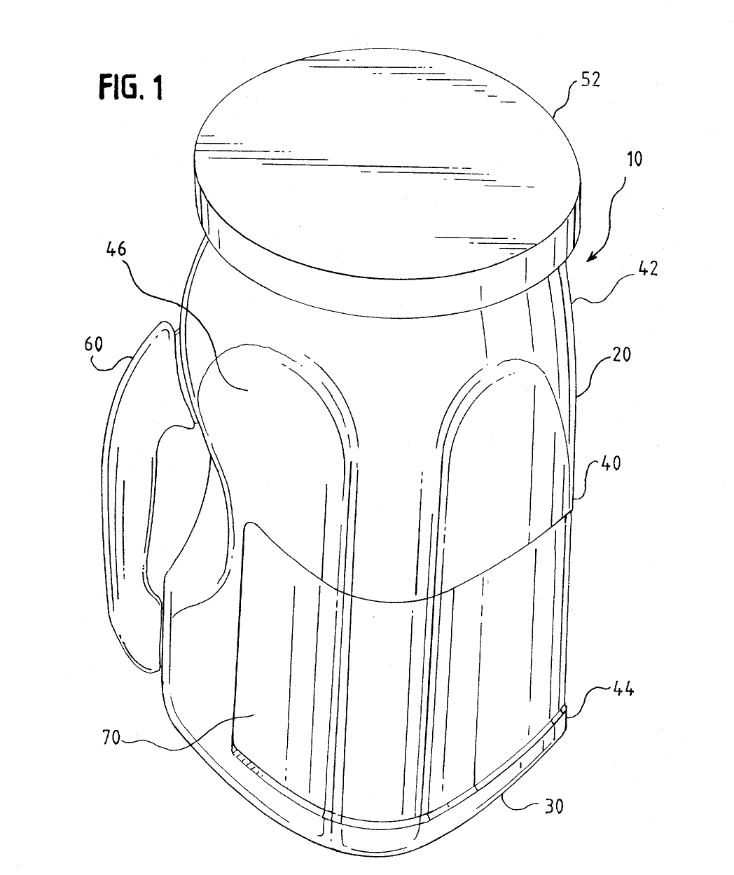

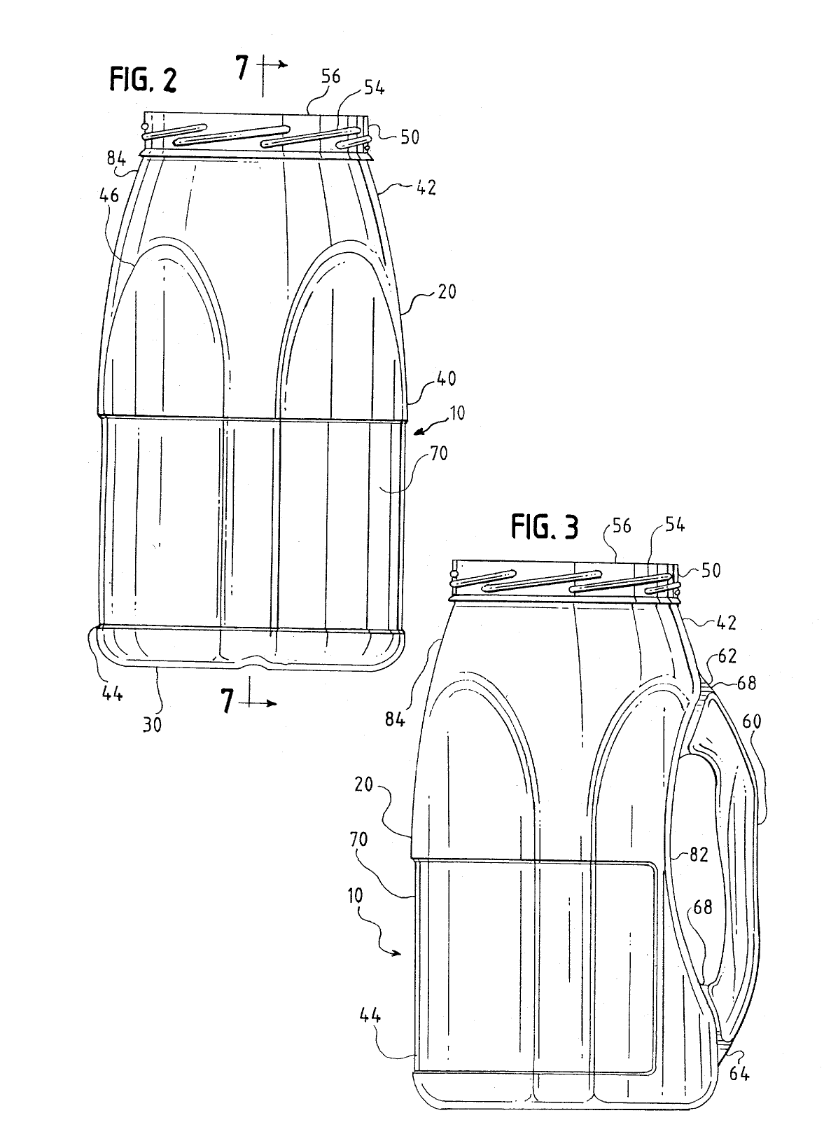

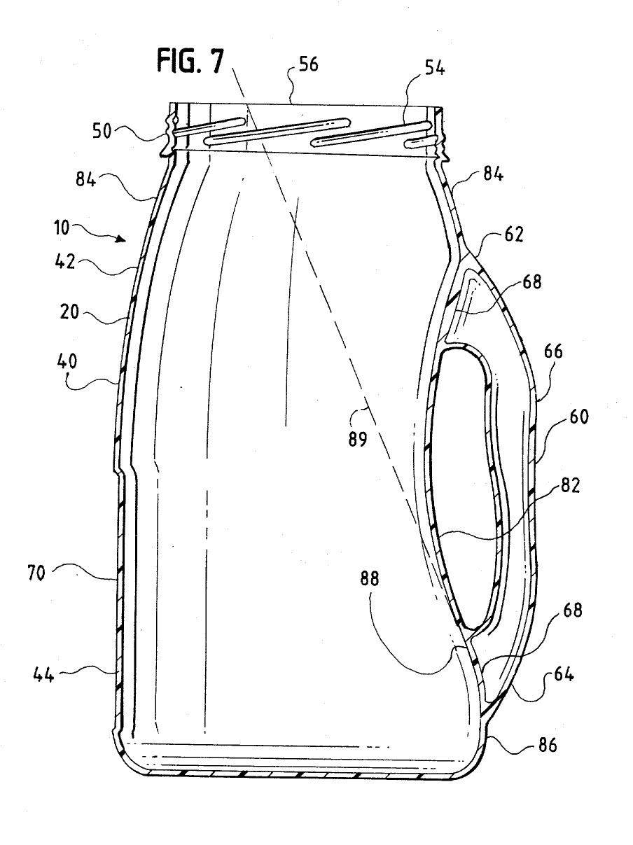

FIGS. 1-7 illustrate a container 10 in accordance with embodiments of the invention. The container 10 is provided with a handle 60 in order to allow for improved handling by a user, such as when transferring the container 10 or when removing product from within the container 10. The container 10 has an opening 56 in order to allow insertion of a utensil into the container 10 for removal of product therein, or to allow the product to be dispensed therethrough. The container 10 has a height selected to maximize shelf space that a user may place the container 10 upon for storage after purchase but prior to use or during use. The container 10 also has a bottom profile or footprint that is generally rectangular in order to maximize shipping and storing of multiple containers 10 when stacked adjacent each other. The region 82 of the container 10 proximate the handle 60 comprises a smooth, gradual arc in order to allow for scraping or removal of product therealong. Similarly, the body 20 of the container 10 includes gradually tapered sidewalls 84 below the neck 50 in order to allow for scraping with a utensil of product therefrom. In addition, the tapered sidewalls 84 proximate the neck 50 and the arcuate region 82 proximate the handle 60 do not present any substantial impediments to dumping or otherwise removing product from the container 10.

In an embodiment of the invention, illustrated in FIGS. 1-7, the container 10 has a generally tall, rectangular profile. The container 10 comprises a generally rectangular bottom wall 30, as illustrated in FIG. 4, and a sidewall 40 extending upwardly therefrom to a neck of the container 50. The sidewall 40 includes an upper portion 42, below the neck 50, and a lower portion 44, above the bottom wall 30. The sidewall 40 includes varius arcuate regions with facets thereon 46. The facets 46 are also arcuate.

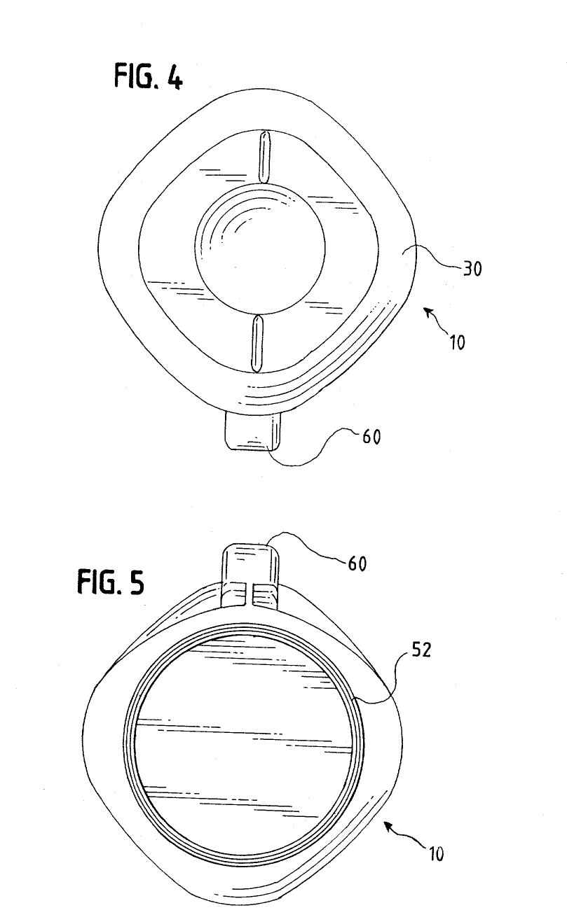

As illustrated in FIG. 3, the container 10 is provided with an opening 56 at the top thereof to allow for product to be dispensed therefrom. In addition, the opening 56 is positioned and sized to allow the insertion of a utensil for assisting in dispensing product. The utensil may also be inserted into the opening 56 in order to scrape the sidewall 40 of the interior of the container 10 in order to remove all of the product therefrom. The opening 56 is preferably between about 105 mm and 125 mm, and is preferably 120 mm. A neck portion 50 is disposed immediately below and around the opening 56. The neck 50 includes threads 54 for engagement with a lid 52, as illustrated in FIG. 1. Alternatively, the neck 50 may be adapted for receiving a lid 60 via a press fit or frictional engagement.

The opening 56 also allows for improved product dispensing from the container 10. Not only may product be removed with a utensil that can be manipulated easier due to the large opening 56, but product may be dumped or otherwise removed easier from the container 10. For example, the large opening 56 may allow an increased amount of air to enter into the opening 56 and assist in dispensing product from the container 10.

The upper end 42 of the sidewall 40, immediately below the neck 50, has a portion 84 with a gradual taper thereto. The tapered region 84 increases in cross-section away from the neck 50. The tapered region 84 allows for a utensil to be scraped therealong in order to remove product without having any substantial protuberances impeding such scraping. The tapered region 84 also lacks significant impediments to the flow of product thereacross and out the opening.

As illustrated in FIG. 3, the container 10 has a handle 60 attached to the sidewall 40. The handle 60 is attached to the container sidewall 40 at the upper and lower ends 42 and 44. The handle 60 allows for convenient handling of the container 10 by a user. For example, the handle 60 allows for the container 10 to be conveniently grasped and unpacked, stored or otherwise shifted prior to use. In addition, the handle 60 allows for simplified dispensing of product from the container 10. For instance, a user may grasp the handle 60 and upend or tilt the container 10 in order to dispense product through the opening 56.

First and second ends 62 and 64 of the handle 60 are attached to the upper and lower ends 42 and 44 of the container sidewall 40 with a connection 68 that prevents entry of product into a hollow region 66 between the first and second ends 62 and 64 of the handle 60. This may be desirable because it prevents product from being inaccessible, such as if the product were to enter the hollow region 66 of the handle 60.

As illustrated in FIGS. 4 and 5, the handle 60 does not extend substantially beyond the footprint of the container 10. This handle configuration reduces interference between adjacent handles 60 when containers 10 are placed on an assembly line for filling and labeling. In addition, having the handle 60 within the perimeter or footprint of the container 10 maximizes the stacking and storage and shipping efficiency for such containers 10.

Between the upper and lower ends 42 and 44 of the sidewall 40, where the first and second ends 62 and 64, respectively, of the handle 60 are attached, an arcuate region 82 of the sidewall 40 projects inwardly toward the interior of the container 10 and has a smooth, gradual arcuate shape. The arcuate region 82, extending between the ends of the handle 62 and 64, preferably spans a distance between fifty and seventy percent of the height of the container.

The arcuate region 82 of the sidewall 40 between the first and second ends 62 and 64 of the handle 60 is configured to provide for easy product removal. For example, the arcuate region 82 allows for product to flow therealong without substantial impediments to flow. Furthermore, a utensil may be inserted into the container 10 and scraped along the arcuate region 82 without encountering any substantial protuberances.

The arcuate region 82 is positioned on the container 10 and sized such that product located in a lower region 86 of the container, between the bottom wall 30 and the lower end 64 of the handle 60, can easily be accessed and removed, such as with a utensil. For example, the lower region 86 may be linearly accessible from the opening. That is, an imaginary line 89 drawn in a plane of symmetry and tangent to a bottom end 88 of the arcuate region 82 extends outwardly through the opening 56. The ratio of the distance between bottom wall 30 of the container 10 and the second end 62 of the handle 60 to the height of the container 10 is between 1:10 and 1:4 in order to minimize any impediment to product removal therefrom.

As described above, the bottom wall 30 has a generally rectangular profile. The perimeter of the bottom wall 30 generally defines a footprint, or maximum horizontal area, that the container 10 occupies. The generally rectangular profile of the container 10 provides for efficient storage thereof. In particular, the generally rectangular configuration of the container 10 maximizes the volume of product that may be contained for a given horizontal area. The generally rectangular configuration results in a container having a greater volume compared to generally circular containers and thus increased product storage.

Moreover, the generally rectangular footprint of the container 10 allows for more efficient shipping of the multiple containers 10 as compared to typical circular containers which do not efficiently maximize the volume for a particular area. For example, there may be substantial unused space when generally circular containers are stacked adjacent to each other on a palate or in a carton for shipping. Typically, only forty one gallon size circular containers can be placed in a carton for shipping. However, the container 10 of the present invention, by having a generally rectangular profile or footprint, maximizes the use of space between adjacent containers 10 during shipping, and in some instances enabling sixty such containers 10 to be packaged for shipping.

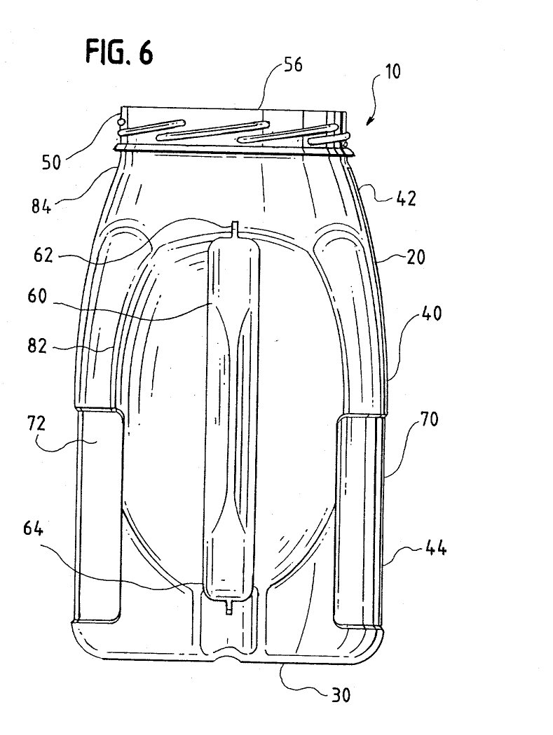

Between the upper and lower ends 42 and 44 of the sidewall 40 a label space 70 is provided for attachment of a label thereto, as illustrated in FIG. 1. The label space 70 has a configuration designed for easy attachment of a label thereto without significant ridges that would interrupt or hinder the attachment of the label thereto. As illustrated in FIG. 6, a portion 72 of the label space 40 is visible when the container 10 is viewed from the back. While the label may be most visible when the container 10 is viewed from the front or sides, a user grasping the handle 60 may place the container onto a shelf for storage with the handle 60 and thus the back of the container 10 facing outward. When in such a configuration, the portion 72 of the label space with a label attached thereto is visible from the back of the container 10 allows for easy identification of the contents in the container 10, irrespective of the orientation of the container 10 on a shelf.

The container 10 is preferably formed using extrusion blow molding techniques. The container 10 may be formed of a polymer, such as polypropylene. If the container 10 is formed using such techniques, the connection 68 between the sidewall 40 and the first and second ends of the handle 60 comprises a pinched off region that prevents product from entering into the hollow region 66 of the handle 60.

The container 10 may be sized to contain one gallon of a product. In a preferred embodiment of the invention, the container 10 is sized to contain one gallon of mayonnaise or another spoonable product. If the product is mayonnaise, the container 10 including the product therein may weigh between and 8 and 9 pounds and may in particular weigh about 8.5 pounds.

The height of the container 10 is selected to maximize storage space in the vertical distance on typical shelving that a user may have. For example, shelving typically comes with 12 to 14 inch gaps between each shelf in the vertical distance. The container 10 of the present invention is configured to maximize the vertical space between such typically shelving units, thereby allowing for a smaller base or footprint of the container 10. Accordingly, the vertical space between shelves is maximized, allowing more containers 10 to fit side by side on each shelf. The height of the container 10 is preferably between 10 and 11.5 inches, and is preferably about 10.7 inches. The bottom wall 30 is preferably between approximately 5 to 6 inches along each side, and is preferably about 5.625 inches along both sides.

From the forgoing, it will be appreciated that the invention provides a container configured for improved handling, storage, shipping, and product dispensing. The invention is not limited to the embodiments described hereinabove or to any particular embodiments. For example, various modifications to the aforementioned dimensions will result in substantially the same invention.

The invention is defined more particularly by the following claims:

In the claims:

1. A hermetically sealed, packaged spoonable product comprising a container having a removable lid and a quantity of product therein, the container comprising:
a molded body defining an interior for containing the product, the body having an upper end, a lower end, and a bottom wall, the upper end of the body having a gradually decreasing cross-section toward the opening to provide a shoulderless surface to facilitate removal of the product from the upper interior with a utensil;
an opening in the upper end of the body having a size effective to permit insertion of the utensil into the interior for removing the product; and
an integrally molded handle attached to the body;
a lower portion of the container extending between the handle and the bottom wall, the lower portion being linearly accessible via the opening.

2. A packaged spoonable product according to claim 1, wherein the handle includes a hollow portion, and a connection between the body and the handle comprises a pinched, non-hollow region to prevent product from entering the hollow portion of the handle.

3. A packaged spoonable product according to claim 1, wherein the container is formed using blow-molding techniques.

4. A packaged spoonable product according to claim 1, wherein the interior of body of the container has a capacity of approximately one gallon of the product.

5. A packaged spoonable product according to claim 1, wherein the upper end of the body is adapted for receiving the lid for allowing access to the opening and the product within the interior of the body.

6. A packaged spoonable product according to claim 1, wherein an imaginary line tangent to the body immediately below the handle and in the lower portion of the container extends through the opening.

7. A packaged spoonable product according to claim 1, wherein the product comprises mayonnaise.

8. A package spoonable product according to claim 1, wherein the body has a footprint defined by the perimeter of the lower end of the body, and the handle generally does not extend substantially beyond the footprint.

9. A package spoonable product according to claim 8, wherein the footprint is generally rectangular.

10. A food product container for a spoonable product, the container comprising:
a generally horizontal bottom wall, the bottom wall defining a footprint of the container;
an annular neck defining an opening for dispensing of feed product;
an upstanding sidewall extending upward from the bottom wall to the neck, the sidewall having an upper end and a lower end, the sidewall upper end having a region of gradually decreasing cross-section adjacent the neck effective to provide an angled surface for removal of the product with a utensil; and
a handle having first and second ends, the first end being attached to the sidewall upper end and the second end being attached to the sidewall lower end, the sidewall having an inwardly extending arcuate region between the first and second handle ends and defining an opening therebetween, the arcuate region having a contour being effective to allow for removal of product from a lower region of the container between the bottom wall of the container and the second end of the handle, the lower region along the sidewall adjacent the second end of the handle being linearly accessible from the opening.

11. A container according to claim 10, wherein the perimeter of the bottom wall defines a footprint of the container and the handle does not extend substantially beyond the footprint of the container.

12. A container according to claim 10, wherein an imaginary line in a vertical plane of symmetry tangent to the arcuate region proximate the second end of the handle extends through the opening to allow access to the lower region of the container.

13. A container according to claim 10, wherein the container has a capacity of about 1 gallon.

14. A container according to claim 13, wherein the container opening is between about 4.65 and 4.85 inches in diameter.

15. A container according to claim 14, wherein the container is between about 10 and 12 inches in height.

16. A container according to claim 10, wherein handle has a hollow region between the first and second ends thereof, the hollow region being sealed between the first and second ends.

17. A container according to claim 16, wherein the container is a polymeric blow-molded container and the first and second handle ends are connected to the sidewall with a pinched region effective to prevent product from entering into the hollow region of the handle.

18. A container according to claim 10, wherein the ratio of the length of the arcuate region and the height of the container is between 1:2 and 7:10.

19. A container according to claim 10, wherein the ratio between the height of the lower region and the container height is between 1:10 and 1:4.

20. A method of evacuating a spoonable product from an interior of a container, the method comprising:
grasping a handle of the container;
removing a lid from a neck of the container to expose an opening of the container;
orienting the container opening in a generally downward direction;
inserting a utensil into the opening of the container; and
evacuating at least some of the spoonable product from within the container with the utensil, including scraping the container interior with the utensil along a gradually decreasing cross-sectional region adjacent the neck and along a gradual arc extending between upper and lower ends of the handle.
